(19) United States
(12) Patent Application Publication
(10) Pub. No.: US 2003/0102602 A1
(43) Pub. Date: Jun. 5, 2003

(54) Method and apparatus for manufacturing honeycomb molding using a high humidity atmosphere

(76) Inventor: Yasunao Miura, Nagoya-City (JP)

Correspondence Address: Nixon & Vanderhye P.C., 8th Floor, 1100 North Glebe Road, Arlington, VA, 22201-4714, US

(21) Appl. No.: 10/303,754

(22) Filed: Nov. 26, 2002

(30) Foreign Application Priority Data
Dec. 4, 2001 (JP) 2001-370392

(51) Int. Cl. B29C 47/12

(52) U.S. Cl. 264/489; 264/177.12; 264/232; 264/630; 264/631; 425/326.1

(57) ABSTRACT

A method and an apparatus for manufacturing a ceramic honeycomb molding having many cells formed by arranging cell walls in a honeycomb pattern. Deformation, wrinkles, cracks, etc., of the cell walls and the like are prevented from occurring. The method for manufacturing the ceramic honeycomb molding having many cells formed by arranging cells walls in a honeycomb pattern comprises an extruding process in which clayey honeycomb moldings 1 are extruded, a drying process in which the honeycomb moldings 1 are dried, and a storage process, between the extruding process and the drying process, in which the honeycomb moldings 1 are maintained in a high humidity atmosphere.

### BACKGROUND OF THE INVENTION

1. Field of the Invention

The present invention relates to a method and apparatus for manufacturing a honeycomb molding.

2. Description of the Related Art

As a catalyst carrier of an automobile exhaust gas purifier, a ceramic honeycomb molding whose cell walls are 0.30 to 0.15 mm thick and whose cylindrical surface skin portion is 0.3 to 1.0 mm thick is normally used these days.

The above-mentioned honeycomb molding is manufactured by extruding a clayey honeycomb molding, which is then baked after being dried. At this time, in order to perform the drying process efficiently, it is a generally employed procedure in which after a certain number of the honeycomb moldings extruded in the previous extruding process are stored temporarily in a palette, etc., the drying process is performed.

However, the honeycomb molding whose cell walls are thin and which has been developed to meet the recent needs for the improvement in performance of the exhaust gas purification, etc., dries spontaneously and quickly and a problem occurs that deformation, wrinkles, cracks, etc., of the cell walls, and the like occur during the storage period.

### SUMMARY OF THE INVENTION

The present invention has been developed by taking the conventional problems mentioned above into account and the objective is to improve the method, for manufacturing a ceramic honeycomb molding, in which cell walls are arranged in a honeycomb pattern and a number of cells are provided, by providing a method and an apparatus for manufacturing a honeycomb molding in which deformation, wrinkles, cracks, etc., of the cell walls and the like are unlikely to occur.

In the first aspect of the present invention, a method for manufacturing a ceramic honeycomb molding, in which cell walls are arranged in a honeycomb pattern and a number of cells are provided, comprises an extruding process in which a clayey honeycomb molding is extruded, a drying process in which the honeycomb molding is dried, and a storage process, between the extruding process and the drying process, in which the honeycomb molding is maintained in a high humidity atmosphere.

In the first aspect, the storage process is positively provided before the clayey honeycomb molding obtained in the extruding process is conveyed into the drying process, and the honeycomb molding is maintained in a high humidity atmosphere, in the storage process.

In the high humidity atmosphere, the amount of water that diffuses from the honeycomb molding to the outside can be kept small. Due to this, it is unlikely that the amount of water contained in the honeycomb molding decreases substantially during the period after it is extruded and before it is conveyed into a drier. In the honeycomb molding maintained in the storage process, therefore, the advance of drying is suppressed and drying shrinkage is unlikely to occur.

As a result, troubles relating to deformation, wrinkles, cracks, etc., of the cell walls and the like of the clayey honeycomb molding can be avoided during the time period after extrusion and before drying.

Therefore, the honeycomb molding obtained through the drying process, a baking process, etc. following the storage process has a high quality without deformation, cracks, etc., of the cell walls and the like.

As described above, according to the first aspect, the method for manufacturing a honeycomb molding in which deformation, wrinkles, cracks, etc., of the cell walls and the like are unlikely to occur can be provided for the manufacture of a ceramic honeycomb molding in which cell walls are arranged in a honeycomb pattern and a number of cells are provided.

In the second aspect of the present invention, an apparatus for manufacturing a honeycomb molding, in which cell walls are arranged in a honeycomb pattern and a number of cells are provided, comprises an extruder that extrudes clayey honeycomb moldings, a drier that dries the honeycomb moldings, and a storage apparatus that stores the honeycomb moldings in a high humidity atmosphere during the time period after the honeycomb moldings are extruded by the extruder and before they are conveyed into the drier.

The second aspect has the storage apparatus that maintains the honeycomb moldings in a high humidity atmosphere during the time period after the honeycomb moldings are extruded by the extruder and before they are conveyed into the drier.

If the above-mentioned storage apparatus is used, the amount of water that diffuses from the honeycomb molding in storage to the outside can be kept small. Due to this, it is unlikely that the amount of water contained in the honeycomb molding decreases substantially during the period from after it is extruded to before it is conveyed into the drier. In the honeycomb molding maintained in the storage apparatus, therefore, the advance of drying is suppressed and drying shrinkage is unlikely to occur.

As a result, the honeycomb moldings stored in the storage apparatus have a high quality without deformation, wrinkles, cracks, etc., of the cell walls and the like.

As described above, according to the second aspect, the apparatus for manufacturing a honeycomb molding in which deformation, wrinkles, cracks, etc., of the cell walls and the like are unlikely to occur can be provided for the manufacture of a ceramic honeycomb molding in which cell walls are arranged in a honeycomb pattern and a number of cells are provided.

A description about a preferred aspect of the first aspect will be given below.

It is preferable that the honeycomb molding is maintained in a high humidity atmosphere where the humidity is not less than 70%, in the storage process.

In this case, as the honeycomb molding can be maintained in an atmosphere where water vapor is almost saturated, the water contained in the honeycomb molding is unlikely to diffuse to the outside.

Due to this, the advance of drying is suppressed and drying shrinkage is unlikely to occur in the honeycomb moldings maintained in the storage process, as described above. As a result, deformation, wrinkles, cracks, etc., of the cell walls and the like are unlikely to occur.

When the humidity is lower than 70%, the above-mentioned effect to suppress drying is degraded.

In addition, the higher the humidity in the high humidity atmosphere, the better the effect is, and it may be not less than 80% or even a supersaturated state may be acceptable.

Next, the honeycomb molding has a cylindrical surface skin portion that covers the side surface thereof, and it is preferable that the thickness of the cylindrical surface skin portion is 0.5 mm or less.

In this case, the honeycomb molding is very fragile and, therefore, deformation, breakage, etc., of the cylindrical surface skin of the honeycomb molding are likely to occur particularly due to drying shrinkage thereof. Therefore, the effect obtained from the method described in the first aspect is particularly effective.

It is preferable that the thickness of the cell wall of the honeycomb molding is 0.125 mm or less.

In this case, the honeycomb molding is very fragile and, therefore, deformation, breakage, etc., of the cell walls of the honeycomb molding are likely to occur particularly due to drying shrinkage thereof. Therefore, the effect obtained from the method described in the first aspect is particularly effective.

Next, in the storage process, it is possible to form the high humidity atmosphere by covering the honeycomb molding with a water shielding member and by holding the water vapor that diffuses from the honeycomb molding within the water shielding member.

In this case, it is possible to keep the amount of water that diffuses from the honeycomb molding below a certain value and to achieve a certain effect to suppress drying. Due to this, in the honeycomb molding stored in such an atmosphere, drying of the honeycomb molding does not advance and deformation, wrinkles, cracks, etc., of the cell walls and the like are unlikely to occur.

As a water shielding member, there can be a resin wrap sheet, a sponge formed so as to wrap the honeycomb molding, etc. Any material may be accepted as long as it prevents water from passing between the honeycomb molding and the outside.

It is preferable that a water shielding member made of such a material is attached closely to the honeycomb molding. The less the volume between the honeycomb molding and the water shielding member, the less is the amount of the water that diffuses and the high humidity atmosphere can be formed effectively.

In the storage process, it is also possible to form the high humidity atmosphere by supplying an ambient temperature mist or a high temperature steam.

By supplying such an ambient temperature mist or a high temperature steam, it is possible to positively control the humidity and to stably form the high humidity atmosphere. In the honeycomb molding stored in the high humidity atmosphere, therefore, it is possible to maintain a state of proper humidity and the effect described in the first aspect is particularly effective.

Next, it is preferable that, in the drying process, the honeycomb moldings are heated and dried by the irradiation of microwaves whose frequency is in the range between 1,000 and 10,000 MHz.

As the microwaves can be conducted through a wave-guide, it is not necessary to provide an electrode near an object to be heated. Due to this, the clayey honeycomb moldings can be heated and dried in a high humidity atmosphere.

When the honeycomb moldings are dried using microwaves in a high humidity atmosphere, rapid drying can be avoided and deformation, wrinkles, cracks, etc. of the cell walls and the like can be prevented from occurring.

As a result, the honeycomb moldings, which have been stored in the storage process with its high quality being maintained, can be dried in the drying process with its high quality being further maintained.

Next, it is preferable that the clayey honeycomb molding is made of cordierite, SiC, Si₃N₄ or mullite.

In this case, the clayey honeycomb molding after extrusion is fragile and it is likely that deformation, breakage, etc., of the cylindrical surface skin portion of the honeycomb molding occur due to drying shrinkage, as described above. Therefore, the effect obtained from the method described in the first aspect is particularly effective.

Next, it is preferable that the storage process has an accumulator function that can allow a difference between the number of the honeycomb moldings supplied to the storage process and that of the honeycomb moldings discharged from the storage process.

The accumulator function is a function that stores the honeycomb moldings in the storage process when the number of the supplied moldings is greater than that of the discharged moldings and conveys out the stored honeycomb moldings when the number of supplied moldings is less than that of discharged moldings.

In this case, even if the number of the supplied moldings differs from that of the discharged moldings constantly or temporarily, the accumulator function of the storage process can absorb the difference. Due to this, it is not necessary to make the process before the storage process and that after the storage process depend on each other. Therefore, the previous process and the subsequent process can be performed independently, and both the processes can always be performed effectively.

As a result, honeycomb moldings of high quality without deformation, wrinkles, cracks, etc., of the cell walls and the like can be manufactured in a manufacturing process the efficiency of which is further improved.

Next, a description of a preferred aspect of the second aspect will be given below.

It is preferable that the storage apparatus maintains the honeycomb moldings in a high humidity atmosphere where the humidity is not less than 70%.

In this case, as the honeycomb moldings can be maintained in an atmosphere with almost saturated humidity, the water contained in the honeycomb moldings is unlikely to diffuse outside.

Therefore, the honeycomb moldings can be prevented from drying, as described above, and deformation, wrinkles, cracks, etc., of the cell walls and the like are unlikely to occur.

When the humidity is lower than 70%, on the other hand, the above-mentioned effect to prevent drying is degraded.

In addition, the higher the humidity in the high humidity atmosphere, the better the effect is, and it may be not less than 80% or a supersaturated state may be acceptable.

It is preferable that the storage apparatus has a water shielding member between the honeycomb molding and the outside.

In this case, the water that diffuses from the honeycomb molding forms a high humidity atmosphere around the honeycomb molding. Therefore, the honeycomb molding can be prevented from drying and deformation, wrinkles, cracks, etc., of the cell walls and the like can be prevented from occurring.

As the water shielding member, there can be used a resin wrap sheet, a sponge formed so as to wrap the honeycomb molding, etc. Any material can be used as long as it prevents water from passing between the honeycomb molding and the outside.

It is more effective if the gap formed between the water shielding member and the honeycomb molding is made smaller.

Next, it is preferable that the storage apparatus has a storage tank that contains the honeycomb moldings and a humidifier that forms a high humidity atmosphere within the storage tank.

It is possible to positively control a high humidity atmosphere by using a humidifier. The honeycomb moldings stored in the storage apparatus can maintain a proper humidity and the effect of the second aspect is particularly effective.

Next, it is preferable that the humidifier supplies an ambient temperature mist or a high temperature steam.

In this case, a high humidity atmosphere can be effectively formed within the storage tank by using a humidifier that has a comparatively simple structure.

As a method for generating the ambient temperature mist, there are methods that utilize ultrasonic waves or centrifugal force. As a method for supplying the high temperature steam, there are methods that utilize a boiler, factory steam, etc.

Next, it is preferable that the drier is designed so that the clayey honeycomb moldings are heated and dried by the irradiation of microwaves whose frequency is in the range between 1,000 and 10,000 MHz.

As the microwaves can be conducted through a wave-guide, it is not necessary to provide an electrode near an object to be heated. Therefore, it is possible to perform drying in a high humidity atmosphere by using a drier that has a comparatively simple structure.

As a result, by using the drier, the honeycomb moldings can be dried while the high quality of the honeycomb moldings that has been maintained in the storage apparatus is further maintained.

Next, it is preferable that the storage apparatus has an accumulator-conveyor that conveys the honeycomb moldings and can allow a difference between the number of the honeycomb moldings supplied to the storage apparatus and that of the honeycomb moldings discharged from the storage apparatus.

The accumulator-conveyor is a conveyor that has the accumulator function. As described above, the accumulator function is a function that stores the honeycomb moldings in the storage process when the number of the supplied moldings is greater than that of the discharged moldings and conveys out the stored honeycomb moldings when the number of the supplied moldings is less than that of the discharged moldings.

In this case, as described above, even if the number of the supplied moldings differs from that of the discharged moldings constantly or temporarily, the accumulator-conveyor can absorb the difference. Due to this, it is not necessary to make the process before the storage and that after the storage depend on each other. Therefore, the previous process and the subsequent process can be performed independently, and both the processes can always be performed efficiently.

As a result, the honeycomb moldings of high excellent quality without deformation, wrinkles, cracks, etc., of the cell walls and the like can be manufactured in a manufacturing process, the efficiency of which has been further improved, by using the apparatus for manufacturing the honeycomb molding that includes the storage apparatus.

Next, it is preferable that the storage apparatus has at least a sensor to detect the presence or absence or the number of the honeycomb moldings in the storage apparatus and that the information based on the presence or absence or the number of the honeycomb moldings detected by the sensor is transferred to the drier.

In this case, it is possible to operate the drier always under an efficient condition according to the information based on the presence or absence or the number of the honeycomb moldings stored in the storage apparatus. Therefore, each honeycomb molding can be dried both efficiently and uniformly in the drier.

Next, it is preferable that the storage apparatus has at least a sensor to detect the presence or absence or the number of the honeycomb moldings therein and that the information based on the presence or absence or the number of the honeycomb moldings detected by the sensor is transferred to the extruder.

In this case, it is possible to operate the extruder always under an optimum condition according to the information based on the presence or absence or the number of the honeycomb moldings stored in the storage apparatus. Therefore, each honeycomb molding can be manufactured efficiently in the extruder.

Next, it is preferable that a photoelectric tube, a laser sensor, or a touch sensor is used as a sensor to detect the presence or absence of the honeycomb molding.

In this case, it is possible to stably detect the honeycomb molding.

The present invention may be more fully understood from the description of the preferred embodiments of the invention set forth below, together with the accompanying drawings.

### BRIEF DESCRIPTION OF THE DRAWINGS

In the drawings:

FIG. 1 is a diagram that illustrates the structure of a storage apparatus and a drier in a first embodiment.

FIG. 2 is a graph that shows a relationship of proper microwave outputs against the numbers of honeycomb moldings in the drier of the first embodiment.

FIG. 3A is a perspective view of the honeycomb molding in the first embodiment.

FIG. 3B shows the thickness of cell walls in the first embodiment.

FIG. 4 is a diagram that shows the structure of a storage apparatus and a drier in a second embodiment.

FIG. 5 is a graph showing a schedule of microwave output values with respect to the operation state cycle of a drier in a third embodiment.

FIG. 6 is a diagram that illustrates a wrap sheet that wraps a honeycomb molding in a fourth embodiment.

FIG. 7 is a diagram that shows the structure of a drier in the fourth embodiment.

FIG. 8 is a graph that shows a relationship of proper microwave outputs against the number of honeycomb moldings for the drier in the fourth embodiment.

### DESCRIPTION OF THE PREFERRED EMBODIMENT

First Embodiment

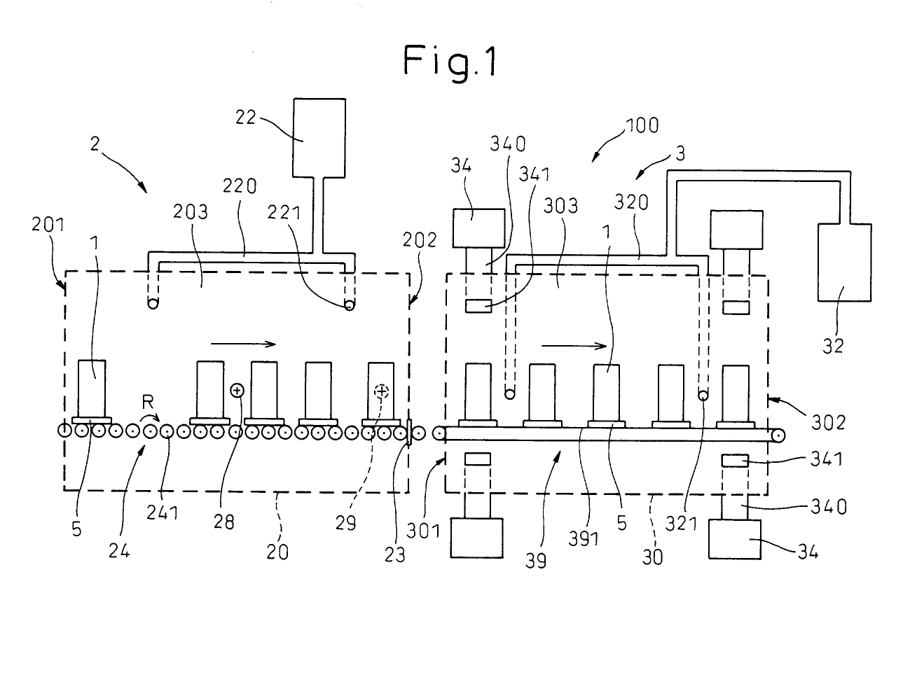

The method for manufacturing a honeycomb molding according to an embodiment of the present invention will be described below with reference to FIG. 1 to FIG. 3.

The present embodiment is a method for manufacturing a ceramic honeycomb molding in which cell walls are arranged in a honeycomb pattern and a number of cells are provided. The manufacturing method of the present embodiment comprises an extruding process in which clayey honeycomb moldings are extruded, a drying process in which the honeycomb moldings are dried, and a storage process, between the extruding process and the drying process, in which the honeycomb moldings are maintained in a high humidity atmosphere. A detailed description will be given below.

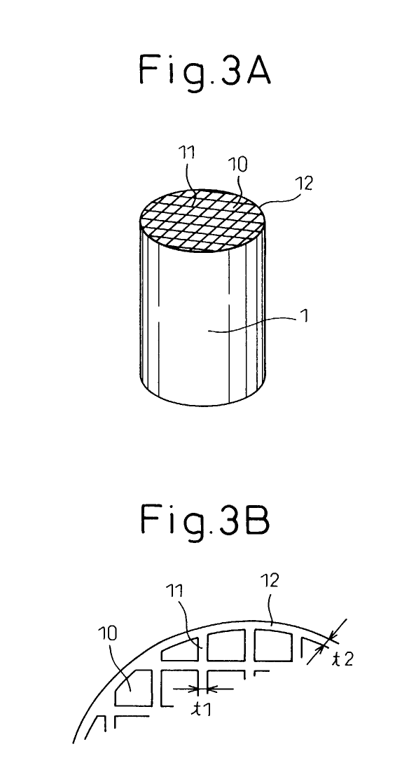

As shown in FIG. 3, a honeycomb molding 1 manufactured in the present embodiment comprises a number of cells 10, formed by arranging cell walls 11, whose thickness t1 is 0.115 mm, in a honeycomb pattern, and a cylindrical surface skin portion 12 whose thickness t2 is 0.3 mm. The cell 10 shape and the whole shape of the honeycomb molding 1 can be modified according to the application.

A manufacturing apparatus 100, which has a structure as shown in FIG. 1, is used to perform the manufacturing method in the present embodiment.

As shown in FIG. 1, the manufacturing apparatus 100 comprises a storage apparatus 2, a drier 3 and an extruder that is not shown. As the extruder, there are several types, such as a plunger type and an auger type, and the auger type is used in the present embodiment (but not shown).

The storage apparatus 2 comprises a storage tank 20 that contains the clayey honeycomb moldings 1, a storage tank humidifier 22 that forms a high humidity atmosphere where the humidity is not less than 70% within the storage tank 20, and an accumulator-conveyor 24 that conveys the honeycomb moldings 1 placed on a conveying tray 5. The accumulator-conveyor 24 comprises a middle photoelectric tube 28 and a rear photoelectric tube 29 that detect the presence or absence of the honeycomb moldings 1, and a stopper 23 that stops the honeycomb moldings 1.

The storage tank 20 has a size large enough to store plural honeycomb moldings 1 at the same time.

In two front and rear points on a side wall 203 of the storage tank 20, two steam pipes 220, which extend and diverge from the storage tank humidifier 22 that serves as a boiler, are connected with their ends opened. These openings are steam inlets 221. The steam that is introduced through the steam inlets 221 is high temperature steam sent from the boiler, as described above, and the temperature is not less than 80° C.

The accumulator-conveyor 24 comprises plural cylindrical rollers 241. Each cylindrical roller 241 is installed so that the axial direction thereof is parallel to the ground surface and perpendicular to the conveying direction. The accumulator-conveyor 24 has a structure in which such cylindrical rollers 241 are aligned in a row from an entrance 201 to an exit 202. Moreover, each cylindrical roller 241 is connected to a motor, not shown, and rotates in the direction of arrow R, as shown in FIG. 1.

The accumulator-conveyor 24 conveys the honeycomb moldings 1 by the frictional force generated between the outer side surface of the cylindrical rollers 241 that rotate and the conveying tray 5. The outer side surface of the cylindrical rollers 241 are made smooth, so that the honeycomb molding 1 can be easily stopped on the accumulator-conveyor 24.

In the present embodiment, the stopper 23 switches the states of the honeycomb molding 1 between the state of being conveyed and the state of being at a stop. As shown in FIG. 1, the stopper 23 protrudes upward near the exit 202 and comes into contact with the side of the conveying tray 5 in the conveying direction.

The middle photoelectric tube 28 is a sensor that is placed near the center of the storage tank 20 and detects the presence or absence of the honeycomb molding 1. When light is blocked in the middle photoelectric tube 28, the presence of the honeycomb molding 1 near the center of the storage tank 20 is detected.

The rear photoelectric tube 29 is a sensor that is placed at the exit 202 of the storage tank 20 and detects the presence or absence of the honeycomb molding 1. When light is blocked in the rear photoelectric tube 29, the presence of the honeycomb molding 1 at the exit 202 of the storage tank 20 is detected.

The drier 3 comprises, as shown in FIG. 1, a drying tank 30 that contains the honeycomb moldings 1, a drying tank humidifier 32 that forms a high humidity atmosphere where the humidity is not less than 70% in the drying tank 30, a microwave generator 34 that supplies microwaves into the drying tank 30, and a belt conveyor 39 that conveys the honeycomb moldings 1 placed on the conveying trays 5 at a constant speed.

As described above, the drying tank 30 in the present embodiment has a size large enough to contain up to 10 honeycomb moldings 1 simultaneously conveyed by the belt conveyor 39.

To four front, rear, top and bottom corners on one of side walls 303, four wave-guides 340, which extend from the four microwave generators 34 are connected with their ends opened. These openings are microwave inlets 341. In the present embodiment, the honeycomb molding 1 is heated and dried by microwaves whose frequency is around 2,450 MHz.

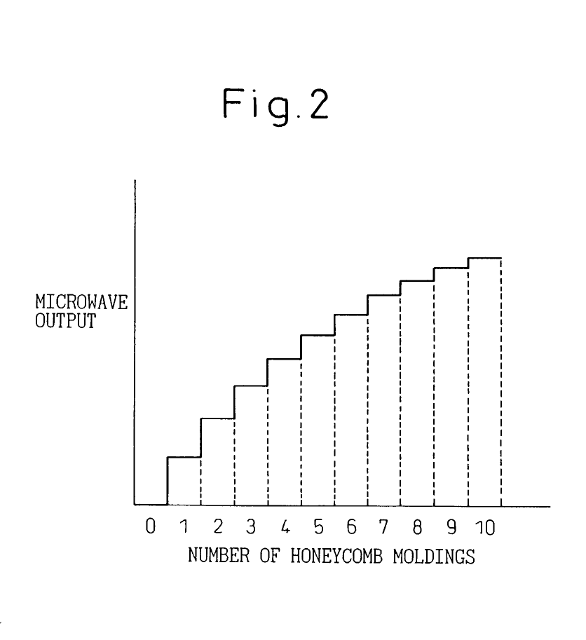

Before arranging the present embodiment, an examination has been made in advance on the proper microwave output values for the drier 3. The result shows that it is proper to adjust a microwave output value according to the number of the honeycomb moldings 1 in the drying tank 30, as shown in FIG. 2.

To two front and rear points on the side wall 303, two steam pipes 320, which extend and diverge from the humidifier 32 that serves as a boiler, are connected with their ends opened. The openings are steam inlets 321. The steam introduced through the steam inlets 321 is the high temperature steam sent from the boiler, as described above, and the temperature is not less than 80° C.

As the storage apparatus 2, the belt conveyor 39 conveys the conveying trays 5 on which the honeycomb moldings 1 are placed. In the present embodiment, therefore, it is possible to convey the honeycomb molding 1 and the conveying tray 5 integrally as one body from the storage apparatus 2 into the drier 3.

The drier 3 is installed so that the entrance 301 thereof and the exit 202 of the storage apparatus 2 oppose each other and the accumulator-conveyor 24 and the belt conveyor 39 oppose each other with a small gap therebetween. Due to this, the honeycomb molding 1 conveyed by the accumulator-conveyor 24 from the storage tank 20 can move onto the belt conveyor 39 without stopping.

Before manufacturing the honeycomb molding 1 using the manufacturing apparatus 100 structured as above, a clayey ceramic material is made by adding an organic binder and water to ceramic material powder, which mainly contains cordierite, and by mixing them, wherein the weight ratio of organic binder, water and ceramic material power is 5:15:100.

Next, the extruding process is performed using the extruder (not shown). In the extruding process, the ceramic material is extruded from a honeycomb extrusion die and, at the same time, it is sequentially cut to a fixed length, and the clayey honeycomb molding 1 is extruded. By repeating the procedure, the clayey honeycomb moldings 1 are extruded successively.

Next, the storage process is performed using the storage apparatus 2, as shown in FIG. 1. The storage apparatus 2 stores the extruded clayey honeycomb moldings 1 standing on the conveying trays 5 and then conveys them into the drier 3 in the later process. In other words, each honeycomb molding 1 is first placed on the conveying tray 5 and both the honeycomb molding 1 and the tray 5 are sequentially placed on the accumulator-conveyor 24, as shown in FIG. 1.

In the present embodiment, the conveying trays 5 are made of cordierite, that is, a porous ceramic whose dielectric loss is 0.1 or less, porous ratio is 10% or more, and cross sectional opening area ratio is 50% or more. The material may be replaced with a urea resin or the like.

The honeycomb moldings 1 are vertically placed on the conveying trays 5 so that the axes of the cells 10 of the honeycomb moldings 1 are directed to the vertical direction and the cells 10 communicate with the pores of the conveying trays 5. Due to this, the gravitational force acting on the honeycomb moldings 1 evenly acts on all the cell walls. Even if, therefore, the extruded clayey honeycomb moldings 1 are fragile, the deformation due to weight can be prevented.

The honeycomb moldings 1 are then sent into the storage tank 20 in a state of being placed on the conveying trays 5, placed on the accumulator-conveyor 24, and conveyed from the entrance 201 of the storage tank 20 toward the exit 202.

As described above, high temperature steam is introduced into the storage tank 20 from the storage tank humidifier 22 and a high humidity atmosphere where the humidity is not less than 70% (not less than 80% in the present embodiment), which is almost a saturated vapor condition, is formed. When the honeycomb moldings 1 are stored in such an atmosphere, the water contained therein is unlikely to diffuse outside. Therefore, the honeycomb moldings 1 can be stored while the high humidity condition of the honeycomb moldings 1 is maintained.

Due to this, the honeycomb moldings 1 in storage are prevented from drying and deformation, wrinkles, cracks, etc., of the cell walls and the cylindrical surface skin portion due to drying shrinkage are unlikely to occur.

In the storage process, therefore, the honeycomb moldings 1 can be stored while their good qualities are maintained.

When the honeycomb moldings 1 are conveyed to the exit 202 of the storage tank 20, the conveying tray 5 comes into contact with the stopper 23 and stops.

On the other hand, as the extruder supplies the honeycomb moldings 1 successively, the honeycomb moldings 1 stop one after one in the storage tank 20. The honeycomb moldings 1, that come to a stop form a queue on the accumulator-conveyor 24 and the queue extends toward the entrance 201 of the storage tank 20.

As described above, when the honeycomb moldings 1 come to a stop one after one, the honeycomb molding 1 at the last position in the queue shields the light on the middle photoelectric tube 28. If this occurs, the storage apparatus 2 judges that the specified number of honeycomb moldings 1 are stored in the storage tank 20 and starts to discharge the honeycomb moldings 1.

In the present embodiment, the position of the middle photoelectric tube 28 is selected so that the specified number of honeycomb moldings 1 is 10, which the drying tank 30 can contain, which will be described later. As described above, by setting the specified number, it is possible to continuously operate the drying process for at least a fixed time period, resulting in an excellent efficiency.

In actual operation, the stopper 23 is first operated and after one of the honeycomb moldings 1 is conveyed out, the rest of the honeycomb moldings 1 are made to come to a stop again by replacing the stopper 23 at its original position.

If the presence of the honeycomb molding 1 is confirmed by the detection result of the rear photoelectric tube 29, one more honeycomb molding 1 is conveyed out and a set of these steps is performed repeatedly at fixed intervals. As described above, as a result of the accumulator-conveyor 24 performing its accumulator function, it is possible to convey the honeycomb moldings 1 into the drying process at fixed intervals.

Next, the drying process is performed to dry the honeycomb molding 1 using the drier 3, as shown in FIG. 1.

The honeycomb moldings 1 conveyed from the storage apparatus 2 move, without stopping, onto the belt conveyor 39 arranged so as to oppose the accumulator-conveyor 24, as described above. The honeycomb moldings 1 that are on the belt conveyor 39 are sent into the drying tank 30 as the belt 391, advances.

As the storage apparatus 2 successively conveys the honeycomb moldings 1 at fixed intervals, as described above, each honeycomb molding 1 sequentially moves onto the belt conveyor 39 and is sent into the drying tank 30.

Each honeycomb molding 1 sent into the drying tank 30 is sequentially irradiated with microwaves, is heated and is dried while it moves from the entrance 301 toward the exit 302 as the belt conveyor 39 advances.

The output value of the microwaves is set, as shown in FIG. 2. Particularly at the inception and ending of conveying the honeycomb moldings 1 into the drying process, the number of the honeycomb moldings 1 in the drying tank 30 changes. In this case, the output value of the microwaves is adjusted according to the number of the honeycomb moldings 1 in the drying tank 30.

As described above, the honeycomb moldings 1 are placed vertically on the conveying trays 5 so that the axes of the cells 10 of the honeycomb molding 1 are directed to the vertical direction and the cells 10 communicate with the pores of the conveying trays 5 when it is dried. Due to this, the cells 10 of each honeycomb molding 1 are open in the vertical direction and at the same time they communicate with the pores in the conveying tray 5. As a result, drying with microwaves can be performed efficiently.

Moreover, as described above, a high humidity atmosphere where the humidity is not less than 70% (not less than 80% in the present embodiment), and the temperature is not less than 80° C., is maintained in the drying tank 30 by the high temperature steam introduced from the humidifier 32. Therefore, the honeycomb moldings 1 irradiated with the microwaves in the drying tank 30 are quickly dried while deformation, wrinkles, cracks, etc., of the cell walls 11 and the cylindrical surface skin portion 12 are prevented from occurring.

Then, the honeycomb moldings 1 are irradiated with microwaves, as described above and, after being dried, are conveyed out from the exit 302 of the drying tank 30.

If the manufacturing apparatus of the honeycomb molding 1 in the present embodiment is used, as described above, it is possible to store the honeycomb moldings 1 while maintaining their good qualities after extrusion, in the storage process. Therefore, the honeycomb moldings 1 to be conveyed into the drying process, the subsequent process, have good qualities. Moreover, it is possible to dry the honeycomb moldings 1 while maintaining their good qualities in the drying process.

Moreover, the storage apparatus 2 in the present embodiment has an accumulator function, as described above. Due to the accumulator function, the storage apparatus 2 can supply the honeycomb moldings 1 to the drier 3 at fixed intervals. Therefore, in the drier 3 in the present embodiment, it is possible to uniformly irradiate each honeycomb molding 1 with microwaves.

Moreover, in the present embodiment, if the number of the honeycomb moldings 1 supplied to the storage apparatus 2 differs constantly or temporarily from that of the honeycomb moldings 1 discharged from the storage apparatus 2, the accumulator function can absorb the difference. If, therefore, the manufacturing apparatus 100 in the present embodiment is used, it is not necessary to make the operational statuses of the drier 3 and the extruder depend on each other and independent operations thereof are possible. This means that the manufacturing apparatus 100 can very efficiently manufacture the honeycomb moldings 1.

As described above, the honeycomb moldings 1 that have good qualities without cracks, wrinkles, etc., of the cylindrical surface skin portion 12 can be manufactured efficiently in the present embodiment.

Second Embodiment

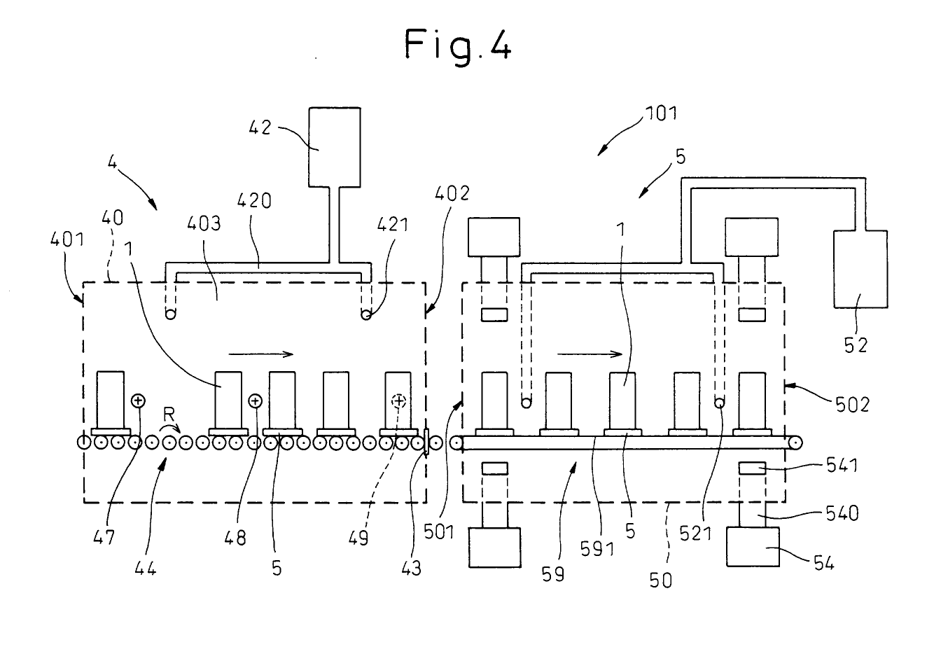

In the present embodiment, instead of the manufacturing apparatus 100 in the first embodiment, a manufacturing apparatus 101 is used to manufacture the honeycomb molding 1 (refer to FIG. 3), as shown in FIG. 4.

Based on the manufacturing apparatus 100 in the first embodiment, a front photoelectric tube 47 is provided in a storage apparatus 4 and a structure, in which the storage apparatus 4 is connected to an extruder and a drier 5 by signal lines, to enable a cooperative operation with the extruder and drier 5, is added to the manufacturing apparatus 101.

The front photoelectric tube 47 is a sensor that detects the presence or absence of the honeycomb molding 1 at an entrance 401 of a storage tank 40. In the present embodiment, the storage apparatus 4 is designed so that signals based on the detection results of the front photoelectric tube 47, a middle photoelectric tube 48 and a rear photoelectric tube 49 are sent to the extruder and the drier 5. The extruder (not shown) and the drier 5 are designed so as to be controlled based on the signals.

The other structures in the manufacturing apparatus 101 are the same as those of the manufacturing apparatus 100 in the first embodiment.

Before the extruded honeycomb moldings 1 are stored in the storage apparatus 4 having the above-mentioned structure, the detected result of the middle photoelectric tube 48 is referred to. If the detected result indicates the “absence” of the honeycomb molding 1, the storage apparatus 4 outputs a “supply request” signal. The extruder that receives the “supply request” signal starts successive extrusion of the honeycomb moldings 1.

As shown in FIG. 1, the respective extruded honeycomb moldings 1 are placed on the conveying trays 5, and then are supplied into the storage apparatus 4 sequentially.

It may happen that the honeycomb molding 1 at the last position in the queue thereof blocks light of the middle photoelectric tube 48. As a result, the storage apparatus 4 judges that the specified number of honeycomb moldings 1 are stored in the storage tank 40 and outputs a “ready” signal. On the other hand, the drier 5 that receives the “ready” signal outputs a “request” signal at fixed intervals, as will be described later.

The storage apparatus 4 that has received the “request” signal refers to the detected result by the rear photoelectric tube 49. When the detected result indicates the “presence” of the honeycomb molding 1, a stopper 43 is operated and one of the honeycomb moldings 1 is discharged.

As described above, the storage apparatus 4 repeats a set of steps from receiving the “request” signal to discharging the honeycomb molding 1 until there is no honeycomb molding 1 left in the storage tank 40.

When the rear photoelectric tube 49 detects the “absence” of the honeycomb molding 1, it outputs a “convey stop” signal to the drier 5.

On the other hand, when the number of the honeycomb moldings 1 supplied by the extruder constantly or temporarily exceeds that of the honeycomb moldings 1 which the drier 5 can deal with, there may be a case where the storage tank 40 is fully filled with the honeycomb moldings 1. In this case, it will happen that the queue formed by the honeycomb moldings 1 extends and the honeycomb molding 1 at the last position in the queue blocks light of the front photoelectric tube 47.

When this happens, the storage apparatus 4 judges the supply by the extruder to be excessive and outputs a “supply stop” signal. Then, the extruder that has received the “supply stop” signal terminates the extrusion of the honeycomb moldings 1.

Next, the drying process is performed using the drier 5, as shown in FIG. 1.

First, the high temperature and high humidity atmosphere is formed and maintained in a drying tank 5, and then the condition is maintained without action until the storage apparatus 4 outputs the “ready” signal. This operational status is referred to as a “standby status”.

As described above, the “ready” signal is a signal output by the storage apparatus 4 when the number of the honeycomb moldings 1 it contains reaches the specified value.

When the drier 5 receives the “ready” signal, it starts the operation of the belt conveyor 39 at a constant speed. Then it outputs the “request” signal to the storage apparatus 2. On the other hand, the storage apparatus 2 that has received the “request” signal discharges one of the honeycomb moldings 1 placed on the conveying tray 5 to the drying tank 50, as described above.

Then, the drier 5 repeats a series of actions of outputting the “request” signal and conveying in and out the honeycomb molding 1 at fixed intervals. This operational status is referred to as a “starting status”.

On the other hand, when there is no honeycomb molding 1 left in the storage tank 20, the storage apparatus 4 outputs the “convey stop” signal.

The drier 5 that has received the “convey stop” signal stops receiving the honeycomb molding 1 until all the honeycomb moldings 1 in the drying tank 50 are discharged. The drier 5 that has discharged all the honeycomb moldings 1 stops the belt conveyor 59. This operational status is referred to as an “ending state”. After the storage tank 50 is emptied, the drier 5 enters the standby status.

As described above, in the manufacturing apparatus in the present embodiment, the storage apparatus 2 outputs a signal in accordance with the number of the honeycomb moldings 1 in the storage tank 40 as well as having the accumulator function. The extruder and the drier 5 are controlled by the signals and change their operational status.

In the present embodiment, therefore, the extruder, the storage apparatus 2 and the drier 3 collaborate in the operation and it is possible to manufacture the honeycomb moldings 1 both continuously and simultaneously. Due to this, it is possible to manufacture the honeycomb moldings 1 of high quality more efficiently using the manufacturing apparatus in the present embodiment.

The effects other than described above are the same as the first embodiment.

Third Embodiment

The present embodiment is an embodiment in which the microwave output of the drier 5 in the second embodiment is automatically controlled. The details will be described below.

As described in the second embodiment, the drier 5 repeatedly performs the cycle of operational statuses in which the standby status, the starting status, the steady operational status and the ending status are sequentially provided in this order and then again the dryer 5 enters the standby status, according to the output signals of the storage apparatus 2.

Based on the drier 5 in the second embodiment, the present embodiment is additionally provided with a counter function to count the number of the honeycomb moldings 1 in the storage tank 50 and a structure in which the output value of the microwaves can be controlled according to the counted number.

The counter function resets itself on receiving the “ready” signal and increases the number of the honeycomb moldings 1 in the storage tank 50 up to the allowable maximum number, and decreases the number when it receives the “convey stop” signal. A period (cycle) of increasing and decreasing a number is identical to a conveying period (cycle) of the belt conveyor 59.

By using such a counter function, it is possible to obtain the exact number of the honeycomb moldings 1 in the drying tank 50 in all of the operational statuses of the drier 5.

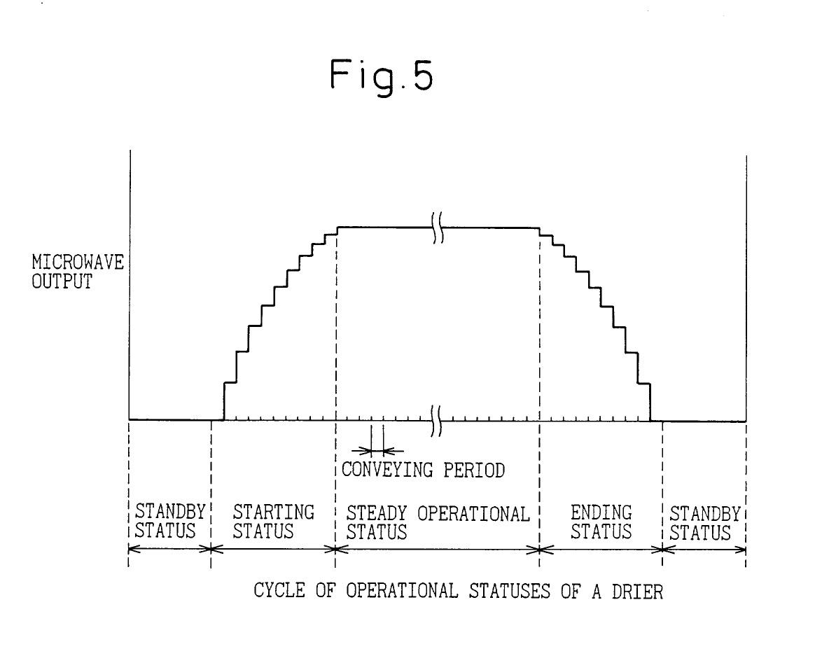

Before the present embodiment is performed, the output values of the microwaves are varied according to the operational cycle of the drier 3 in a specified schedule, as shown in FIG. 5, based on the output values of the microwaves shown in FIG. 2. In the graph shown in FIG. 5, the abscissa indicates the cycle of the operational statuses of the drier 3 and a scale indicates the conveying period. The ordinate indicates the output values, of microwaves, to be set.

When the honeycomb moldings 1 are dried using the drier 5, the output value of the microwaves is automatically controlled according to the operational status of the drier 5, as shown in FIG. 5.

As described above, by using the manufacturing apparatus of the honeycomb molding 1 that includes the drier 5, it is possible to perform the manufacturing process of the honeycomb molding 1 both efficiently and automatically, including the control of the output value of the microwaves.

Due to this, it is possible to dry all of the honeycomb moldings 1 conveyed into the drying tank 30 both uniformly and properly, and at the same time to operate the drier 3 very efficiently.

The effects other than those described above are the same as the second embodiment.

Fourth Embodiment

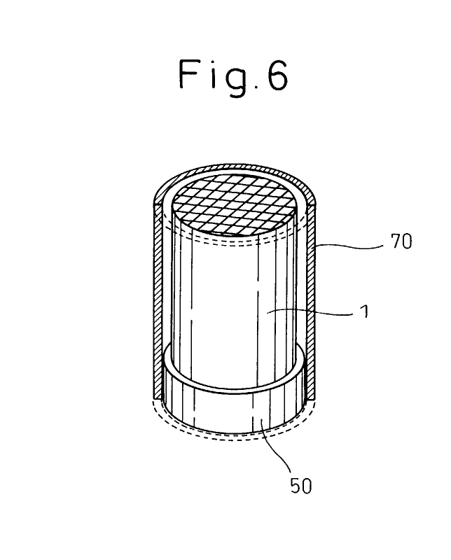

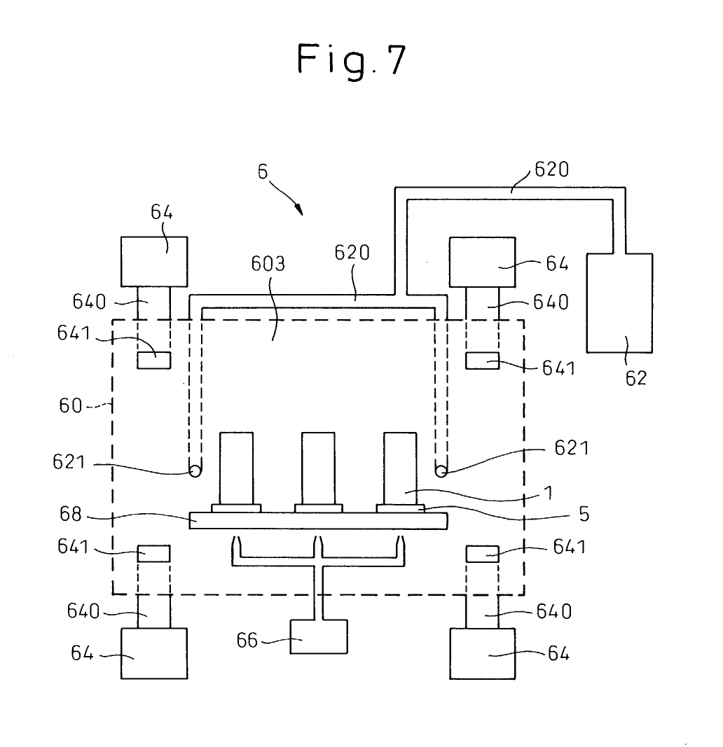

In the present embodiment, instead of the storage apparatus in the first embodiment, the honeycomb molding 1 is wrapped with a wrap sheet 70 made of polyvinylidene chloride resin, as shown in FIG. 6, and placed side by side in a palette-shaped container for storage. Moreover, as shown in FIG. 7, instead of the drier in the first embodiment, for example, a batch type drier 6 is used for drying. In other words, the manufacturing processes from the extruding process through the storage process to the drying process are performed successively, in the first embodiment, but each process is performed separately in the present embodiment different from the first embodiment.

Although the wrap sheets 70 may be made of polypropylene, nylon or the like, the wrap sheet 70 used in the present embodiment is made of polyvinylidene chloride resin. In addition, sponge or the like formed so as to wrap the honeycomb molding 1 may be used, instead of the wrap sheet 70. Any material may be used as long as it prevents water from passing between the honeycomb molding 1 and the outside, and a material such as Teflon (registered trademark) may be used.

The drier 6 comprises a drying tank 60 that contains the honeycomb moldings 1, a humidifier 62 that forms a high humidity atmosphere where the humidity is not less than 70% in the drying tank 60, and a microwave generator 64 that provides microwaves at frequency of 2450 MHz to the drying tank 60.

In the drying tank 60, a pedestal 68 that can support up to five honeycomb moldings 1 placed on the conveying tray 5 is provided. The pedestal 68 has plural holes penetrating vertically for ventilation.

To four left, right, top and bottom corners of one of side walls 603 of the drying tank 60, four wave-guides 640, which extend from the four microwave generators 64, are connected with their ends opened. These openings are microwave inlets 641. Moreover, the drying tank 60 has an entrance (not shown) so that the honeycomb molding 1 can be carried in and out.

Moreover, to two left and left points on the side wall 603, two steam pipes 620, which extend and diverge from the humidifier 62 that serves as a boiler, are connected with their ends opened. These openings are steam inlets 621. The steam that is introduced through the steam inlet 621 is high temperature steam sent from the boiler, as described above, and the temperature is not less than 80° C.

In the above-mentioned structure, the honeycomb moldings 1 placed on the conveying trays 5 are first wrapped with the wrap sheets 70 in the storage process in the present embodiment. The honeycomb molding 1 is wrapped, as a whole, so that the inside and the outside of the wrap sheet do not communicate with each other.

Then, the honeycomb moldings 1 wrapped with the wrap sheet 70 are placed side by side in a palette-shaped container (not shown) for storage. In the present embodiment, the palette-shaped container in which the honeycomb moldings 1 are placed side by side is stored where direct sunlight does not reach.

Next, the drying process is performed using the batch type drier 6, as shown in FIG. 7. First, the honeycomb moldings 1 wrapped with the wrap sheets 70 are carried out, as shown in FIG. 5. Then, the honeycomb moldings 1 with conveying trays 5 are arranged on the pedestal 68 in a state of being placed on the conveying trays 5.

In this state, high temperature steam is introduced from the humidifier 62 into the drying tank 60 to form a high humidity atmosphere where the humidity is not less than 70% and, at the same time, microwaves are introduced from the microwave generator 64 for microwave heating.

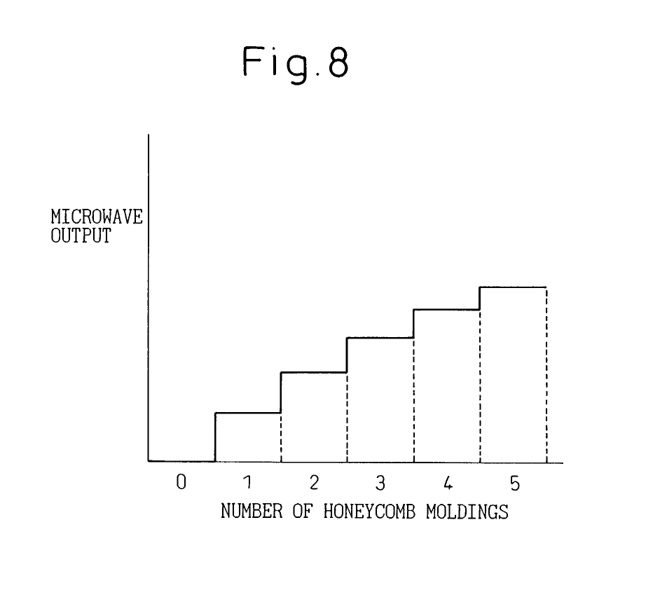

In the present embodiment, the microwave irradiation output in the drier 6 is varied according to the number of the honeycomb moldings 1 carried into the drying tank 60. In actual operation, the microwave irradiation output is adjusted based on the graph shown in FIG. 8. In the graph, the abscissa indicates the number of the honeycomb moldings 1 in the drying tank 30 and the ordinate indicates the proper microwave irradiation output.

As described above, by wrapping the honeycomb molding 1 with the wrap sheet 70 after the extruding process, the water that diffuses from the honeycomb molding 1 is kept in a space formed between the wrap sheet 70 and the honeycomb molding 1. Then, a high humidity atmosphere is formed in the space. Therefore, the honeycomb molding 1 can be maintained in a high humidity atmosphere and the effect to suppress the advance of drying and to prevent drying shrinkage from occurring can be obtained, as the first embodiment.

As a result, the honeycomb moldings 1 are irradiated with microwaves and dried quickly in the drying tank 60 while deformation, wrinkles, cracks, etc., of the cell walls 11 and the cylindrical surface skin portion 12 are prevented from occurring.

If the wrap sheet 70 is made to come close to the honeycomb molding 1 so that the volume of the space between the wrap sheet 70 and the honeycomb molding 1 can be reduced, the effect of preventing the honeycomb molding 1 from drying can be further improved.

Moreover, the honeycomb moldings 1 can be prevented from being heated excessively by adjusting the microwave output value according to the number of the honeycomb moldings 1 in the drying tank 60, as described above.

As described above, in the present embodiment, the honeycomb moldings 1 of high quality can be manufactured very efficiently. Particularly in the manufacture of very fragile ceramic honeycomb moldings that have many cells formed by the cell walls of 0.115 mm in thickness arranged in a honeycomb pattern and a cylindrical surface skin portion of 0.3 mm in thickness, it is possible to efficiently manufacture the honeycomb moldings 1 of high quality without deformation, wrinkles, cracks, etc., of the cell walls, and of the cylindrical surface skin portion, using a comparatively small manufacturing apparatus.

Other effects are the same as those in the first embodiment.

While the invention has been described by reference to specific embodiments chosen for the purposes of illustration, it should be apparent that numerous modifications could be made thereto by those skilled in the art without departing from the basic concept and scope of the invention.

1. A method for manufacturing a ceramic honeycomb molding having many cells formed by arranging cell walls in a honeycomb pattern, comprises
an extruding process in which a clayey honeycomb moldings are extruded,
a drying process in which the honeycomb moldings are dried, and
a storage process, between the extruding process and the drying process, in which the honeycomb moldings are maintained in a high humidity atmosphere.

2. A method for manufacturing a honeycomb molding, as set forth in claim 1, wherein the honeycomb moldings are maintained in a high humidity atmosphere where the humidity is not less than 70% in the storage process.

3. A method for manufacturing a honeycomb molding, as set forth in claim 1, wherein the honeycomb molding has a cylindrical surface skin portion that covers the side outer surface thereof, and the thickness of which is not more than 0.5 mm.

4. A method for manufacturing a honeycomb molding, as set forth in claim 1, wherein the thickness of the cell walls of the honeycomb moldings is not more than 0.125 mm.

5. A method for manufacturing a honeycomb molding, as set forth in claim 1, wherein the high humidity atmosphere is formed by covering the honeycomb molding with a water shielding member to prevent the water diffusing from the honeycomb molding inside the water shielding member in the storage process.

6. A method for manufacturing a honeycomb molding, as set forth in claim 1, wherein the high humidity atmosphere is formed by supplying an ambient temperature mist or a high temperature steam in the storage process.

7. A method for manufacturing a honeycomb molding, as set forth in claim 1, wherein the drying process is a process in which the honeycomb moldings are heated and dried by the irradiation of microwaves the frequency range of which is 1,000 to 10,000 MHz.

8. A method for manufacturing a honeycomb molding, as set forth in claim 1, wherein the clayey honeycomb molding is made of cordierite, SiC, Si₃N₄ or mullite.

9. A method for manufacturing a honeycomb molding, as set forth in claim 1, wherein the storage process comprises an accumulator function that allows a difference between the number of the honeycomb moldings supplied to the storage process and that of the honeycomb moldings discharged from the storage process.

10. An apparatus for manufacturing a honeycomb molding having many cells formed by arranging cell walls in a honeycomb pattern, comprises
an extruder to extrude clayey honeycomb moldings,
a drier to dry the honeycomb moldings, and
a storage apparatus to maintain the honeycomb moldings in a high humidity atmosphere during the time period from the time the honeycomb moldings are extruded by the extruder until they are conveyed into the drier.

11. An apparatus for manufacturing a honeycomb molding, as set forth in claim 10, wherein the storage apparatus maintains the honeycomb molding in the high humidity atmosphere where the humidity is not less than 70%.

12. An apparatus for manufacturing a honeycomb molding, as set forth in claim 10, wherein the storage apparatus comprises a water shielding member arranged between the honeycomb molding and the outside.

13. An apparatus for manufacturing a honeycomb molding, as set forth in claim 10, wherein the storage apparatus comprises a storage tank to contain the honeycomb moldings and a humidifier to form a high humidity atmosphere in the storage tank.

14. An apparatus for manufacturing a honeycomb molding, as set forth in claim 13, wherein the humidifier supplies an ambient temperature mist or a high temperature steam.

15. An apparatus for manufacturing a honeycomb molding, as set forth in claim 10, wherein the drier heats and dries the clayey honeycomb moldings by irradiating microwaves the frequency range of which is 1,000 to 10,000 MHz thereto.

16. An apparatus for manufacturing a honeycomb molding, as set forth in claim 10, wherein the storage apparatus comprises an accumulator-conveyor to convey the honeycomb molding, being designed so as to adjust a difference between the number of the honeycomb moldings supplied into the storage apparatus and that of the honeycomb moldings conveyed out of the storage apparatus.

17. An apparatus for manufacturing a honeycomb molding, as set forth in claim 10, wherein the storage apparatus comprises a sensor to check the presence or absence, or the number of the honeycomb moldings in the storage apparatus, and is designed so as to transfer the information, based on the presence or absence, or the number of the honeycomb moldings detected by the sensor, to the drier.

18. An apparatus for manufacturing a honeycomb molding, as set forth in claim 10, wherein the storage apparatus comprises a sensor to detect the presence or absence, or the number of the honeycomb moldings in the storage apparatus, and transfers the information, based on the presence or absence, or the number of the honeycomb moldings detected by the sensor, to the extruder.

19. An apparatus for manufacturing a honeycomb molding, as set forth in claim 17, wherein the sensor to detect the presence of absence of the honeycomb moldings is a photoelectric tube, a laser sensor, or a touch sensor.
